(19) United States
(12) Patent Application Publication
(10) Pub. No.: US 2023/0059417 A1
(43) Pub. Date: Feb. 23, 2023

(54) Multi-Screen User Experience for Autonomous Vehicles

(71) Applicant: Waymo LLC, Mountain View, CA (US)

(72) Inventors: Maria Moon, Mountain View, CA (US); Matthew Hall, Cupertino, CA (US); Peter Crandall, San Jose, CA (US); Orlee Smith, San Jose, CA (US); Dean Harding, Santa Clara, CA (US)

(21) Appl. No.: 17/485,955

(22) Filed: Sep. 27, 2021

Related U.S. Application Data
(60) Provisional application No. 63/235,859, filed on Aug. 23, 2021.

(51) Int. Cl. B60W 50/14; B60W 10/04; B60W 10/18; B60W 10/20; B60K 35/00; B60W 60/00

(52) U.S. Cl. CPC B60W 50/14; B60W 10/04; B60W 10/18; B60W 10/20; B60K 35/00; B60W 60/001; B60W 2050/146; B60W 2540/227; B60K 2370/16; B60K 2370/186; B60K 2370/182; B60K 2370/73; B60W 2540/225; B60K 2370/774; B60W 2556/45

(57) ABSTRACT

The technology relates to providing an enhanced user experience for riders in autonomous vehicles. Two or more displays may be arranged at different locations within a vehicle to provide notifications, alerts and control options. Information may be dynamically and automatically switched between these displays, as well as a rider's own personal communication device(s). What information to present on each screen can depend on factors including how many riders are in the vehicle, their seating within the vehicle, how their attention is focused and/or display location and size. Certain information may be mirrored or otherwise duplicated among multiple screens while other information can be presented asymmetrically on different screens. Presented information may include a “monologue” from the vehicle explaining why a driving action is taken or not taken, alerts about important conditions, buttons to control certain functionality of the vehicle, or other information that may be of interest to the rider.

### CROSS-REFERENCE TO RELATED APPLICATIONS

This application claims the benefit of the filing date of U.S. Provisional Patent Application No. 63/235,859, filed Aug. 23, 2021, the entire disclosure of which is incorporated by reference herein.

### BACKGROUND

Autonomous vehicles, such as vehicles that do not require a human driver, can be used to aid in the transport of passengers from one location to another. Such vehicles may operate in an autonomous mode without a person providing all of the driving input. In such a driving mode, it may be important to communicate information to a passenger about the status of a ride or other information. Information that is not presented effectively can result in confusion or otherwise distract from the ride experience.

### BRIEF SUMMARY

The technology relates to providing an enhanced user experience for riders in autonomous vehicles. Two or more displays may be arranged at different locations within a vehicle to provide notifications, alerts and control options. Information may be dynamically and automatically switched between these displays, as well as a rider's own personal communication device(s). This can be done to reduce information density on a single screen. What information to present on each screen may depend on various factors, including how many riders are in the vehicle, their seating within the vehicle (e.g., front seat v. rear seat, left side v. right side), how their attention is focused, display location and size, etc. Certain information may be mirrored or otherwise duplicated among multiple screens (e.g., estimated arrival time, route map or important notifications, rider support), while other information can be presented asymmetrically (e.g., vehicle controls or rider-specific information).

According to one aspect of the technology, a vehicle is configured to operate in an autonomous driving mode. The vehicle comprises a perception system, a driving system, a positioning system, a user interface system and a control system. The perception system includes one or more sensors. The one or more sensors are configured to receive sensor data associated with objects in an external environment of the vehicle. The driving system includes a steering subsystem, an acceleration subsystem and a deceleration subsystem to control driving of the vehicle. The positioning system is configured to determine a current position of the vehicle. The user interface system includes a set of in-vehicle displays. A first one of the in-vehicle displays is oriented to display a first user interface to a first row of seats and a second row of seats. And a second one of the in-vehicle displays is oriented to display a second user interface to the second row of seats but not the first row of seats. The control system includes one or more processors. The control system is operatively coupled to the driving system, the perception system, the positioning system and the user interface system. The control system is configured to: identify a seating arrangement of one or more riders within the vehicle; select content for presentation to the one or more riders via the user interface system, based on at least one of the identified seating arrangement, a type of information to be presented, a priority of the information to be presented, or a ride status of the vehicle; and display the selected content on one or both of the first and second in-vehicle displays.

Identification of the seating arrangement may include identifying which seat each of the one or more riders is seated in. Display of the selected content on one or both of the first and second in-vehicle displays may be further based on at least one of a given rider's gaze, the given rider's seated pose, or a line-of-sight visibility between the given rider and each of the set of in-vehicle displays. The first in-vehicle display may be disposed on or adjacent to a dashboard of the vehicle. The second in-vehicle display may be in a console disposed between either the first row of seats or the second row of seats. Or the second in-vehicle display may be disposed along a seat back or a headrest of one of the front row seats. Furthermore, identification of the seating arrangement may be based on information from one or more interior sensors of the vehicle.

The control system may be further configured to transmit a portion of the content to a client device of a given one of the one or more riders for presentation to the given rider. Here, the portion of the content may be a subset of the content selected for display on one or both of the first and second in-vehicle displays. The first user interface may be a peripheral user interface and the second user interface may be a rider active user interface.

According to another aspect of the technology, a computer-implemented method is provided for a vehicle configured to operate in an autonomous driving mode. The method comprises identifying, by one or more processors of the vehicle, a seating arrangement of one or more riders within the vehicle; selecting, by the one or more processors, content for presentation to the one or more riders via a user interface system of the vehicle based on at least one of the identified seating arrangement, a type of information to be presented, a priority of the information to be presented, or a ride status of the vehicle, in which the user interface system includes a set of in-vehicle displays, a first one of the in-vehicle displays oriented to display a first user interface to a first row of seats and a second row of seats, a second one of the in-vehicle displays oriented to display a second user interface to the second row of seats but not the first row of seats; and displaying the selected content on one or both of the first and second in-vehicle displays while the vehicle is operating in the autonomous driving mode.

Identifying the seating arrangement may include identifying which seat each of the one or more riders is seated in. Displaying the selected content on one or both of the first and second in-vehicle displays may be further based on at least one of a gaze direction of a given one of the one or more riders, the given rider's seated pose, or a line-of-sight visibility between the given rider and each of the set of in-vehicle displays. Identifying the seating arrangement may be based on information obtained from one or more interior sensors of the vehicle.

In one example, the method may further comprise transmitting a portion of the content to a client device of a given one of the one or more riders for presentation to the given rider. Here, the portion of the content may be a subset of the content selected for display on one or both of the first and second in-vehicle displays.

The first user interface may be a peripheral user interface and the second user interface may be a rider active user interface. The rider active user interface may include a set of virtual vehicle control buttons that enable a given rider to control one or more features of the vehicle. The one or more features of the vehicle may include at least one starting a ride, adding a stop to the ride, or requesting remote assistance. Alternatively or additionally, the one or more features of the vehicle may include an option to cast content from a client device of a given one of the one or more riders through an entertainment system of the vehicle.

### BRIEF DESCRIPTION OF THE DRAWINGS

FIGS. 1A-B illustrate an example passenger-type vehicle configured for use with aspects of the technology.

FIGS. 1C-D illustrate an example articulated bus arrangement for use with aspects of the technology.

FIG. 2 is a block diagram of systems of an example vehicle in accordance with aspects of the technology.

FIGS. 3A-D illustrate interior cabin views of example configurations in accordance with aspects of the technology.

FIGS. 4A-B illustrate rider position and gaze direction in accordance with aspects of the technology.

FIG. 5 illustrates a multi-display configuration in accordance with aspects of the technology.

FIGS. 6A-D illustrate examples of different message presentations for a rear-only seating arrangement in accordance with aspects of the technology.

FIGS. 7A-H illustrate examples of different message presentations for a front-only seating arrangement in accordance with aspects of the technology.

FIGS. 8A-E illustrate examples of different message presentations for a front and rear seating arrangement in accordance with aspects of the technology.

FIGS. 9A-B illustrates an example system in accordance with aspects of the technology.

FIG. 10 illustrates an example method in accordance with aspects of the technology.

### DETAILED DESCRIPTION

Aspects of the technology take a holistic approach to information dissemination to one or more riders in a vehicle that is operating in an autonomous driving mode. Rider seating, display positioning, types of messaging, rider focus and/or other factors are used to determine what information is presented on each display, as well as when to update or switch information between displays. Certain information may include a “monologue” from the vehicle explaining why a driving action is taken or not taken (e.g., turning instead of going straight due to construction, or waiting at a green light due to a pedestrian in the roadway), alerts about important conditions, virtual control buttons to control certain functionality of the vehicle, or other information that may be of interest to the rider (e.g., in-vehicle entertainment options, autonomous riding tips, etc.). This approach is able to provide a robust multi-screen rider experience that minimizes information overload.

### Example Vehicle Systems

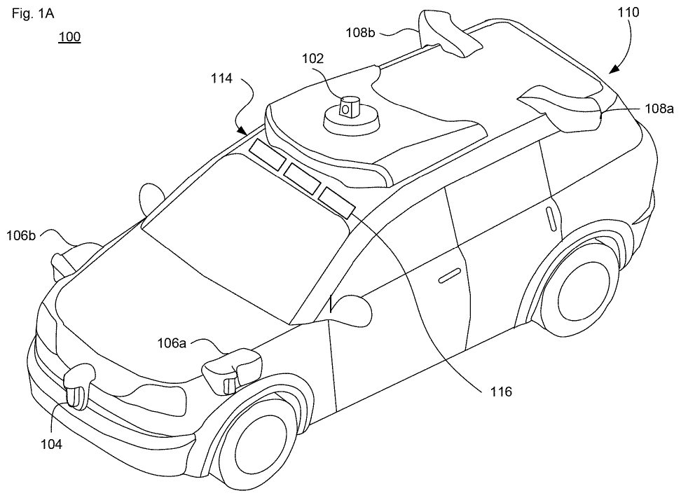

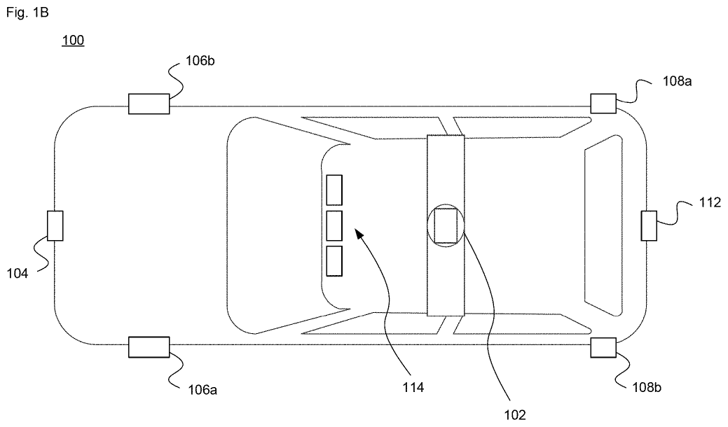

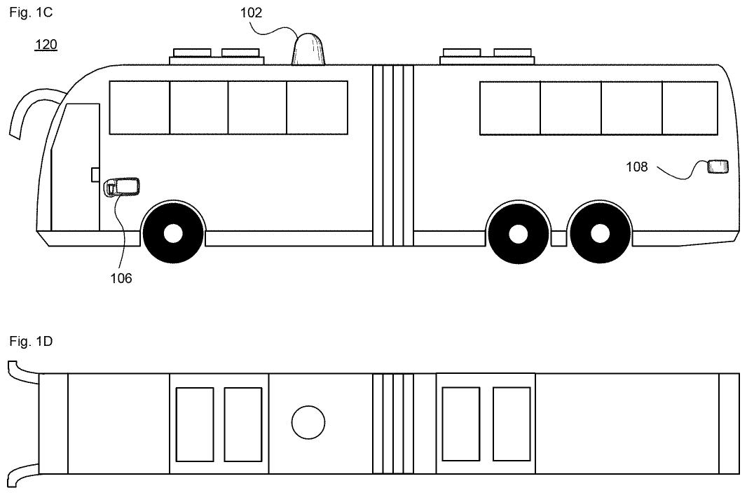

FIG. 1A illustrates a perspective view of an example passenger vehicle 100, such as a minivan, sport utility vehicle (SUV) or other vehicle. FIG. 1B illustrates a top-down view of the passenger vehicle 100. As shown, the passenger vehicle 100 includes various sensors for obtaining information about the vehicle's external environment, which enable the vehicle to operate in an autonomous driving mode. For instance, a roof-top housing 102 may include a lidar sensor as well as various cameras, radar units, infrared and/or acoustical sensors. Housing 104, located at the front end of vehicle 100, and housings 106a, 106b on the driver's and passenger's sides of the vehicle, may each incorporate lidar, radar, camera and/or other sensors. For example, housing 106a may be located in front of the driver's side door along a quarter panel of the vehicle. As shown, the passenger vehicle 100 also includes housings 108a, 108b for radar units, lidar and/or cameras also located towards the rear roof portion of the vehicle. Additional lidar, radar units and/or cameras (not shown) may be located at other places along the vehicle 100. For instance, arrow 110 indicates that a sensor unit (112 in FIG. 1B) may be positioned along the rear of the vehicle 100, such as on or adjacent to the bumper. And arrow 114 indicates a series of sensor units 116 arranged along a forward-facing direction of the vehicle. In some examples, the passenger vehicle 100 also may include various sensors for obtaining information about the vehicle's interior spaces (not shown).

FIGS. 1C-D illustrate an example of another type of vehicle 120, such as an articulated bus. As with the passenger vehicle 100, the articulated bus 120 may include one or more sensor units disposed along different areas of the vehicle.

By way of example, each sensor unit may include one or more sensors, such as lidar, radar, camera (e.g., optical or infrared), acoustical (e.g., microphone or sonar-type sensor), inertial (e.g., accelerometer, gyroscope, etc.) or other sensors (e.g., positioning sensors such as GPS sensors). While certain aspects of the disclosure may be particularly useful in connection with specific types of vehicles, the vehicle may be any type of vehicle including, but not limited to, cars, trucks, motorcycles, buses, recreational vehicles, etc.

There are different degrees of autonomy that may occur for a vehicle operating in a partially or fully autonomous driving mode. The U.S. National Highway Traffic Safety Administration and the Society of Automotive Engineers have identified different levels to indicate how much, or how little, the vehicle controls the driving. For instance, Level 0 has no automation and the driver makes all driving-related decisions. The lowest semi-autonomous mode, Level 1, includes some drive assistance such as cruise control. Level 2 has partial automation of certain driving operations, while Level 3 involves conditional automation that can enable a person in the driver's seat to take control as warranted. In contrast, Level 4 is a high automation level where the vehicle is able to drive fully autonomously without human assistance in select conditions. And Level 5 is a fully autonomous mode in which the vehicle is able to drive without assistance in all situations. The architectures, components, systems and methods described herein can function in any of the semi or fully-autonomous modes, e.g., Levels 1-5, which are referred to herein as autonomous driving modes. Thus, reference to an autonomous driving mode includes both partial and full autonomy. High-level fully autonomous driving as discussed herein includes operating according to either level 4 or level 5 criteria.

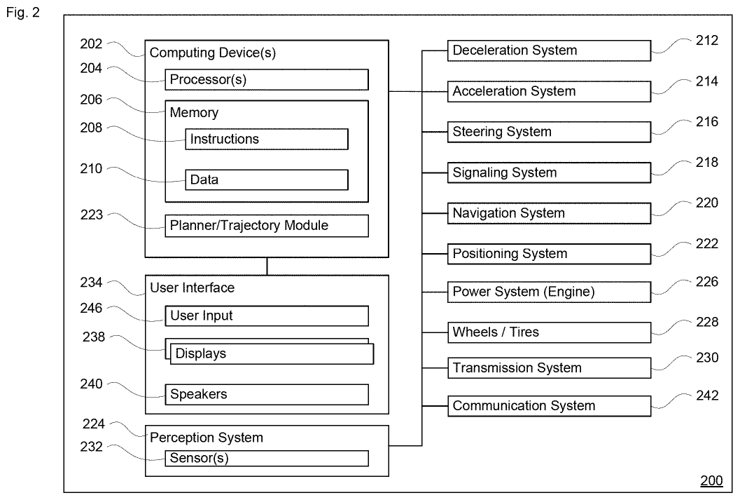

FIG. 2 illustrates a block diagram 200 with various components and systems of an exemplary vehicle, such as passenger vehicle 100 or bus 120, to operate in an autonomous driving mode. As shown, the block diagram 200 includes one or more computing devices 202, such as computing devices containing one or more processors 204, memory 206 and other components typically present in general purpose computing devices. The memory 206 stores information accessible by the one or more processors 204, including instructions 208 and data 210 that may be executed or otherwise used by the processor(s) 204. The computing system may control overall operation of the vehicle when operating in an autonomous driving mode.

The memory 206 stores information accessible by the processors 204, including instructions 208 and data 210 that may be executed or otherwise used by the processors 204. The memory 206 may be of any type capable of storing information accessible by the processor, including a computing device-readable medium. The memory is a non-transitory medium such as a hard-drive, memory card, optical disk, solid-state, etc. Systems may include different combinations of the foregoing, whereby different portions of the instructions and data are stored on different types of media.

The instructions 208 may be any set of instructions to be executed directly (such as machine code) or indirectly (such as scripts) by the processor(s). For example, the instructions may be stored as computing device code on the computing device-readable medium. In that regard, the terms “instructions”, “modules” and “programs” may be used interchangeably herein. The instructions may be stored in object code format for direct processing by the processor, or in any other computing device language including scripts or collections of independent source code modules that are interpreted on demand or compiled in advance. The data 210 may be retrieved, stored or modified by one or more processors 204 in accordance with the instructions 208. In one example, some or all of the memory 206 may be an event data recorder or other secure data storage system configured to store vehicle diagnostics and/or obtained sensor data, which may be on board the vehicle or remote, depending on the implementation.

The processors 204 may be any conventional processors, such as commercially available CPUs. Alternatively, each processor may be a dedicated device such as an ASIC or other hardware-based processor. Although FIG. 2 functionally illustrates the processors, memory, and other elements of computing devices 202 as being within the same block, such devices may actually include multiple processors, computing devices, or memories that may or may not be stored within the same physical housing. Similarly, the memory 206 may be a hard drive or other storage media located in a housing different from that of the processor(s) 204. Accordingly, references to a processor or computing device will be understood to include references to a collection of processors or computing devices or memories that may or may not operate in parallel.

In one example, the computing devices 202 may form an autonomous driving computing system incorporated into vehicle 100. The autonomous driving computing system is configured to communicate with various components of the vehicle. For example, the computing devices 202 may be in communication with various systems of the vehicle, including a driving system including a deceleration system 212 (for controlling braking of the vehicle), acceleration system 214 (for controlling acceleration of the vehicle), steering system 216 (for controlling the orientation of the wheels and direction of the vehicle), signaling system 218 (for controlling turn signals), navigation system 220 (for navigating the vehicle to a location or around objects) and a positioning system 222 (for determining the position of the vehicle, e.g., including the vehicle's pose). The autonomous driving computing system may employ a planner/trajectory module 223, in accordance with the navigation system 220, the positioning system 222 and/or other components of the system, e.g., for determining a route from a starting point to a destination or for making modifications to various driving aspects in view of current or expected traction conditions.

The computing devices 202 are also operatively coupled to a perception system 224 (for detecting objects in the vehicle's environment), a power system 226 (for example, a battery and/or internal combustion engine) and a transmission system 230 in order to control the movement, speed, etc., of the vehicle in accordance with the instructions 208 of memory 206 in an autonomous driving mode which does not require or need continuous or periodic input from a passenger of the vehicle. Some or all of the wheels/tires 228 are coupled to the transmission system 230, and the computing devices 202 may be able to receive information about tire pressure, balance and other factors that may impact driving in an autonomous mode.

The computing devices 202 may control the direction and speed of the vehicle, e.g., via the planner/trajectory module 223, by controlling various components. By way of example, computing devices 202 may navigate the vehicle to a destination location completely autonomously using data from the map information and navigation system 220. Computing devices 202 may use the positioning system 222 to determine the vehicle's location and the perception system 224 to detect and respond to objects when needed to reach the location safely. In order to do so, computing devices 202 may cause the vehicle to accelerate (e.g., by increasing fuel or other energy provided to the engine by acceleration system 214), decelerate (e.g., by decreasing the fuel supplied to the engine, changing gears, and/or by applying brakes by deceleration system 212), change direction (e.g., by turning the front or other wheels of vehicle 100 by steering system 216), and signal such changes (e.g., by lighting turn signals of signaling system 218). Thus, the acceleration system 214 and deceleration system 212 may be a part of a drivetrain or other type of transmission system 230 that includes various components between an engine of the vehicle and the wheels of the vehicle. Again, by controlling these systems, computing devices 202 may also control the transmission system 230 of the vehicle in order to maneuver the vehicle autonomously, such as in accordance with a short-term trajectory or long-term route to a destination, which may be created by the planner/trajectory module 223.

Navigation system 220 may be used by computing devices 202 in order to determine and follow a route to a location. In this regard, the navigation system 220 and/or memory 206 may store map information, e.g., highly detailed maps that computing devices 202 can use to navigate or control the vehicle. The map information need not be entirely image based (for example, raster). The map information may include one or more roadgraphs or graph networks of information such as roads, lanes, intersections, and the connections between these features. Each feature may be stored as graph data and may be associated with information such as a geographic location and whether or not it is linked to other related features. For instance, a stop light or stop sign may be linked to a road and an intersection, etc. In some examples, the associated data may include grid-based indices of a roadgraph to allow for efficient lookup of certain roadgraph features. As an example, these maps may identify the shape and elevation of roadways, lane markers, intersections, crosswalks, speed limits, traffic signal lights, buildings, signs, real time traffic information, vegetation, or other such objects and information. The lane markers may include features such as solid or broken double or single lane lines, solid or broken lane lines, reflectors, etc. A given lane may be associated with left and/or right lane lines or other lane markers that define the boundary of the lane. Thus, most lanes may be bounded by a left edge of one lane line and a right edge of another lane line.

The perception system 224 includes sensors 232 for detecting objects external to the vehicle. The sensors 232 are located in one or more sensor units around the vehicle. The detected objects may be other vehicles, obstacles in the roadway, traffic signals, signs, trees, bicyclists, pedestrians, etc. The sensors 232 may also detect certain aspects of weather or other environmental conditions, such as snow, rain or water spray, or puddles, ice or other materials on the roadway.

By way of example only, the perception system 224 may include one or more light detection and ranging (lidar) sensors, radar units, cameras (e.g., optical imaging devices, with or without a neutral-density filter (ND) filter), positioning sensors (e.g., gyroscopes, accelerometers and/or other inertial components), infrared sensors, acoustical sensors (e.g., microphones or sonar transducers), and/or any other detection devices that record data which may be processed by computing devices 202. Such sensors of the perception system 224 may detect objects outside of the vehicle and their characteristics such as location, orientation, size, shape, type (for instance, vehicle, pedestrian, bicyclist, etc.), heading, speed of movement relative to the vehicle, etc.

The perception system 224 may also include other sensors within the vehicle to detect objects and conditions within the vehicle, such as in the passenger compartment. For instance, such sensors may detect, e.g., one or more persons, pets, packages, etc., as well as conditions within and/or outside the vehicle such as temperature, humidity, etc. This can include detecting where the passenger(s) is sitting within the vehicle (e.g., front passenger seat versus second or third row seat, left side of the vehicle versus the right side, etc.). The interior sensors may detect the proximity, position and/or line of sight of the passengers in relation to one or more display devices of the passenger compartment. Still further sensors 232 of the perception system 224 may measure the rate of rotation of the wheels 228, an amount or a type of braking by the deceleration system 212, and other factors associated with the equipment of the vehicle itself.

The raw data obtained by the sensors can be processed by the perception system 224 and/or sent for further processing to the computing devices 202 periodically or continuously as the data is generated by the perception system 224. Computing devices 202 may use the positioning system 222 to determine the vehicle's location and perception system 224 to detect and respond to objects when needed to reach the location safely, e.g., via adjustments made by planner/trajectory module 223, including adjustments in operation to deal with occlusions and other issues. In addition, the computing devices 202 may perform calibration of individual sensors, all sensors in a particular sensor assembly, or between sensors in different sensor assemblies or other physical housings.

As illustrated in FIGS. 1A-B, certain sensors of the perception system 224 may be incorporated into one or more sensor assemblies or housings. In one example, these may be integrated into the side-view mirrors on the vehicle. In another example, other sensors may be part of the roof-top housing 102, or other sensor housings or units 106a,b, 108a,b, 112 and/or 116. The computing devices 202 may communicate with the sensor assemblies located on or otherwise distributed along the vehicle. Each assembly may have one or more types of sensors such as those described above.

Returning to FIG. 2, computing devices 202 may include all of the components normally used in connection with a computing device such as the processor and memory described above as well as a user interface subsystem 234. The user interface subsystem 234 may include one or more user inputs 236 (e.g., a mouse, keyboard, touch screen and/or microphone) and a set of display devices 238 (e.g., monitors having screens or any other device that is operable to display information to riders in the vehicle). In this regard, an internal electronic display may be located within a cabin of the vehicle (not shown) and may be used by computing devices 202 to provide information to passengers within the vehicle. By way of example, displays may be located, e.g., along the dashboard, on the rear of the front row of seats, on a center console between the front or middle row seats, along the doors of the vehicle, extending from an armrest, etc. Other output devices, such as speaker(s) 240 may also be located within the passenger vehicle.

The passenger vehicle also includes a communication system 242. For instance, the communication system 242 may also include one or more wireless configurations to facilitate communication with other computing devices, such as passenger computing devices within the vehicle, computing devices external to the vehicle such as in another nearby vehicle on the roadway, and/or a remote server system. The network connections may include short range communication protocols such as Bluetooth™, Bluetooth™ low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

While the components and systems of FIG. 2 are generally described in relation to a passenger vehicle arrangement, as noted above the technology may be employed with other types of vehicles, such as the articulate bus 120 of FIGS. 1C-D. In this type of larger vehicle, the user interface elements such as displays, microphones and speakers may be distributed so that each passenger has his or her own information presentation unit and/or one or more common units that can present status information to larger groups of passengers.

### Example In-Vehicle Display Configurations

In view of the structures and configurations described above and illustrated in the figures, various aspects will now be described in accordance with aspects of the technology.

A self-driving vehicle, such as a vehicle with level 4 or level 5 autonomy that can perform driving actions without human operation, has unique requirements and capabilities. This includes making driving decisions based on a planned route, received traffic information, and objects in the external environment detected by the onboard sensors. However, in many instances the rider(s) may desire status updates or other information from the vehicle about what the vehicle is currently doing. In other instances, important notifications or rider support assistance may need to be communicated to the rider(s). And in still other instances, one or more riders may be able to control different features of the vehicle (e.g., heating/air conditioning, opening windows or doors, turning interior lights on or off, etc.). For each of these situations, the information and how it is communicated can have a positive impact on the rider's experience.

By way of example, aspects of the technology can combine information from the perception system (e.g., detected objects including signage and lights), stored maps (e.g., roadgraph), and planned actions (e.g., from the planner module) to generate timely and relevant messages to the user via an app on the user's device. Important notifications, such as a delay or change in route, may be time-sensitive. And vehicle controls should be readily accessible to a rider regardless of where they are positioned within the vehicle.

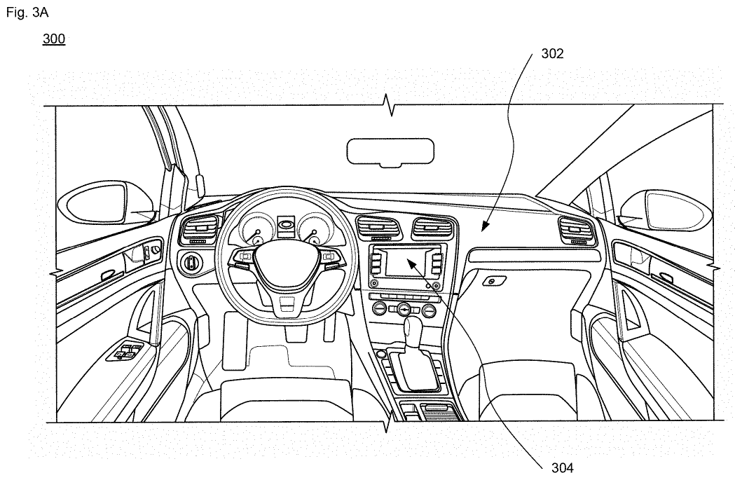

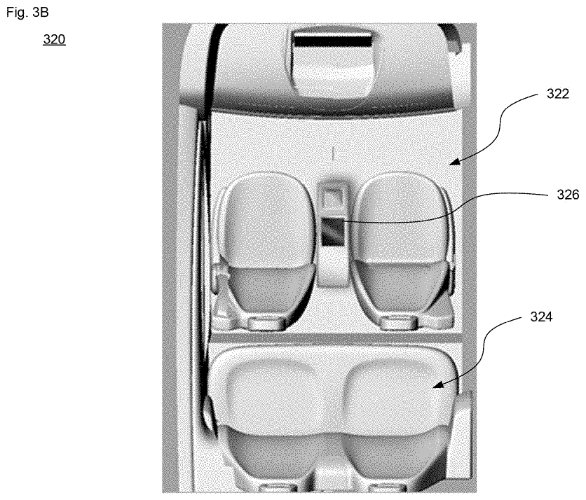

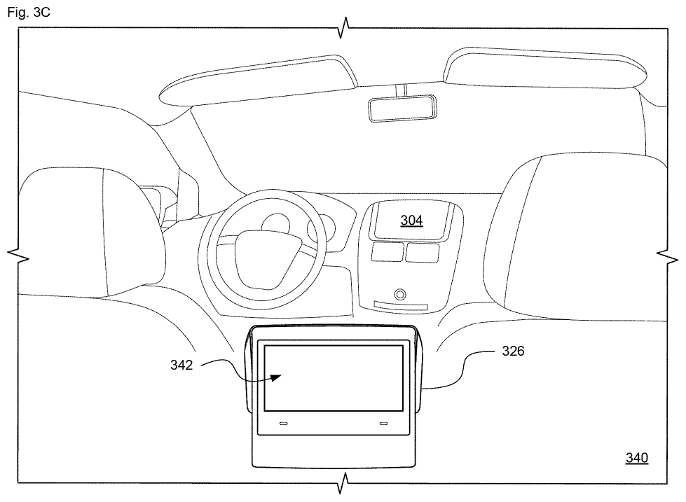

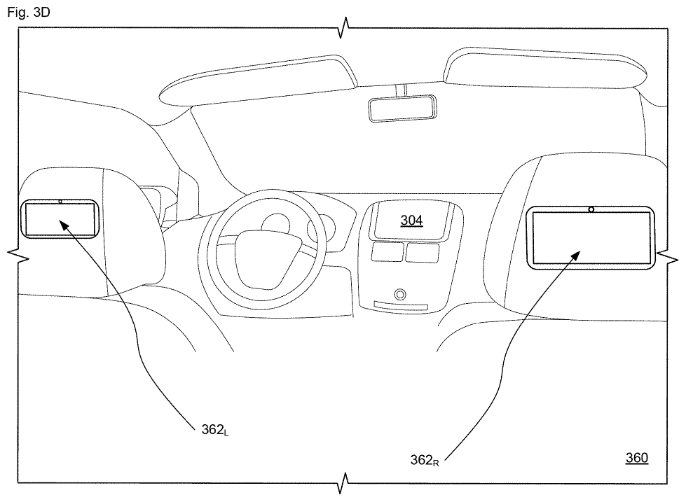

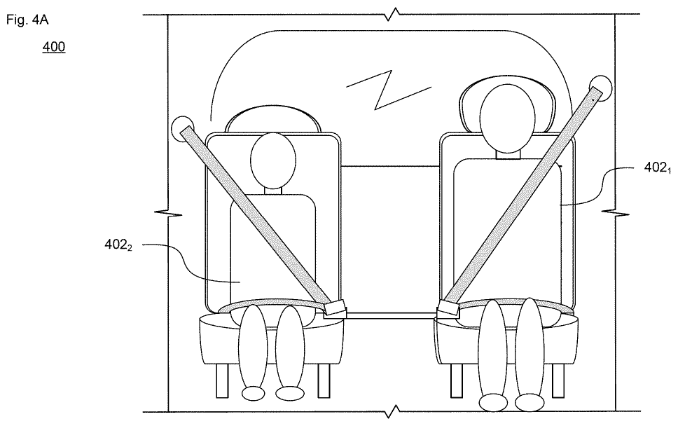

FIG. 3A illustrates an example view 300 within a cabin of the vehicle 100, for instance as seen from the front seats. In this view, a dashboard or console area 302 which includes an electronic display 304 is visible. Although vehicle 100 includes a steering wheel, gas (acceleration) pedal, or brake (deceleration) pedal which would allow for a semiautonomous or manual driving mode where a passenger would directly control the steering, acceleration and/or deceleration of the vehicle via the drivetrain, these inputs are not necessary for a fully autonomous driving mode (level 4 or level 5 autonomy). Rider input may be provided by interaction with the vehicle's user interface subsystem 234 and/or a wireless network connection for an app on the passenger's mobile phone or other personal computing device (e.g., a wearable device, tablet, etc.), such as via the communication system 244. By way of example, the electronic display 304 along the dashboard may include a touch screen or other user input device for entering information by a rider, such as a destination, etc. Alternatively, electronic display 304 may merely provide information to the rider(s) and need not include a touch screen or other interface for user input.

FIG. 3B illustrates a top-down view 320 of a vehicle cabin of an example vehicle, such as vehicle 100 of FIG. 1A. As shown, the cabin includes a front seat area 322 and a rear seat area 324. While this is a two-row vehicle, other vehicles may have three or more rows of seating. In this scenario, a center console 326 may be disposed between the front seats. FIG. 3C presents a view 340 from the second row of seats in the rear sear area of the vehicle. Here, console 326 is shown as being positioned between the front seats. In view 340, display screen 342 of the console is shown facing the second row of seats for easy viewings and access by passengers.

FIG. 3D illustrates view 360 indicating an alternative arrangement from FIG. 3C. Here, instead of a single centrally located console viewable by riders in the second row of seats, individual displays 262L and 262R may be located along the seat backs or headrests of the front row of seats. In this case, riders in the left and right rear seats would have their own display, which is easily accessible for that particular rider.

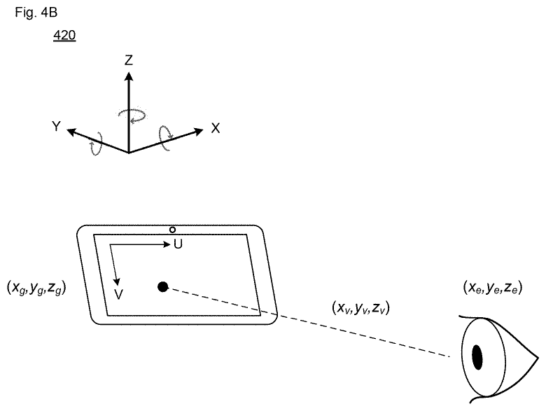

Regardless of where the different in-vehicle displays are placed (e.g., in a center console arrangement as in FIG. 3C or directly in front of the rear seats as in FIG. 3D, with or without a dashboard-based display), differences in rider size, seating and/or pose may affect how information could be presented to them. For instance, FIG. 4A illustrates a view 400 of two riders 4021 and 4022 seating in a back or middle row of a vehicle. As shown, the riders 402 have different sizes, and so it may be easier for one to view a display positioned in front of them or in a center console rather than a display positioned along the dashboard.

Furthermore, even if it were assumed that each rider had an unobstructed line of sight to the different in-vehicle displays, the pose of each rider (e.g., position in a seat and orientation relative to a nominal feature of the vehicle, such as their placement relative to the rear-view mirror or center of the dashboard) and/or the gaze of each rider may differ.

By way of example, view 420 of FIG. 4B illustrate an example of rider gaze direction when viewing information on an in-vehicle display. Information presented on a two-dimensional (2D) display screen may be associated with a 2D coordinate system (e.g., U, V screen coordinates as shown). There is also information associated with the three-dimensional (3D) world view based on the rider's eye position and gaze direction. In particular, eye position (xₑ, yₑ, zₑ) and gaze direction (xᵥ, yᵥ, zᵥ) may be provided in the world coordinate system, with the gaze position on the screen being (x_{g}, y_{g}, z_{g}). Understanding the rider's gaze, seated pose and/or line of sight visibility to each in-vehicle display may be used to determine what information to present, and when to present it, on each in-vehicle display.

As discussed further below, various signals from different onboard systems (e.g., the planner/trajectory module, the perception system, etc.) and information received from remote services can be used to generate messages in real time about various conditions and situations in the vehicle's external environment. This information may be passed across a user interface bridge (or bus). In one architecture, the onboard computing system may listen for the signals or other information and distill it for presentation to one or more riders via their client devices and/or in-vehicle display components. According to one aspect, a user experience (UX) framework is generated for what kind of data is to be passed to the app on a client device, what is presented by the vehicle directly via its in-vehicle displays, and what is transmitted to both the device app and the vehicle's UI system.

The framework may incorporate whether the information is directly or contextually relevant to autonomous driving decisions. For example, the onboard system may detect a red light and, as a result, the vehicle makes a driving-related decision to stop at the red light. In such cases having a high confidence of accuracy (e.g., that the traffic signal is red) and relevance (e.g., that a red light will result in a delay before the vehicle can proceed through the intersection), the default of the framework may be to always present information to the user regarding the driving decision. So here, the rider will receive an indication that the vehicle is stopping at a red light. In contrast, contextually relevant information may not explicitly be related to a current driving decision but can have an impact on the user. Gridlock is one example. Here, there are one or more other vehicles in front of the vehicle. This may not change any driving decisions, but the gridlock will likely affect arrival time at a destination. Thus, in this case, the system may elect to present contextual information (e.g., informing the riders that the vehicle is entering a slow zone, is currently gridlocked, etc.). This contextual information may be very important to the rider so the user can gauge the trustworthiness of the arrival time.

Rankings or thresholds may be employed by the framework when choosing how to disseminate the information. For instance, in one scenario a ranking order example would be, from highest to lowest, (1) features that make the vehicle stop (e.g., red light, train on a railroad crossing, etc.), (2) features that the vehicle predicts will cause a long pause in driving (e.g., a stop sign or a yield sign at a busy intersection, unprotected left turn, etc.), (3) features that can cause the vehicle to move very slowly (e.g., a construction zone, traffic, etc.) such as at lower than a posted speed, and (4) features that may make the vehicle deviate from a normal course of action (e.g., an emergency vehicle causing the vehicle to pull over or excessive traffic or unplanned obstacles causing the vehicle to take an alternative route). Time may often be a threshold considered by the framework. For instance, micro-hesitations (e.g., on the order of 1-10 seconds) may be less perceptible to a user, but a slightly longer delay (e.g., on the order of 30-45 seconds) may be more apparent. Thus, in the latter case the vehicle may inform the rider about the reason for the delay, but in the former case the reason for the delay may be omitted.

The timing may be factored in for relevance to the rider and for the ranking order. By way of example, the framework may include restrictions on messaging hierarchy and timing. For instance, messages that are classified as “priority” messages may supersede one or more lower priority messages. In one scenario, the ranking system may be on a scale of 1-4, with 1 being the highest priority.

The framework may also select whether additional descriptive information may be presented, such as including a section at the top (or bottom) of the displayed UI that gives more context about the current scenario/state of operation. By way of example, an “Approaching a red light” text string might be displayed in addition to a callout bubble on the map with a red light icon. In contrast, for other signals such as a green light, the callout bubble may be presented without a further textual description to avoid cluttering the interface. Alternatively or additionally, the visual display may include changing the route color in the case of “slow zones”.

Thus, according to aspects of the technology, the vehicle reports (e.g., via a monologue message it generates) its current status to the rider based on the vehicle's knowledge about what is going on in the immediate environment. There are several aspects to this functionality. In particular, interaction with the environment/external world as detected by the vehicle, impact of this interaction on the rider, and communication of the information to the rider (either directly from the vehicle's displays or via an app on the rider's device or both). Non-visual information may also be presented to the rider in addition or alternatively to displaying it. By way of example, the monologue messages may be verbally spoken aloud to the user. Such voice-based messages may be available on demand, such as when the user asks what the car is doing. The same messaging architecture described above for visual display also applied to audible monologue information.

Information about certain vehicle systems and components may be presented via the monologue. For instance, this can include informing riders about the window status, such as which windows may be rolled down or which are locked. The client device app may also allow the user to control operation for opening and closing the windows. Similarly, the windshield wiper status or cabin temperature may be presented to or controlled by the passenger. Here, while the vehicle may not need to activate the wipers, the user may want to have a better view of what is happening around the vehicle, and so may turn the wipers on or control the wiper speed. Similarly, the user may be able to control heating or air conditioning within the cabin, turn the defrosters on or off, etc. In one scenario, information about whether the wipers are on could be an indicator of light rain. In another scenario, precipitation may be detected by one or more of the vehicle sensors. In this case a monologue message may inform the user to stay inside until the vehicle arrives, or to have an umbrella ready before exiting the vehicle. External (ambient) temperature information may also be communicated, for instance to suggest that the user bundle up before exiting the vehicle.

### Example Scenarios

Information may be selected for presentation to riders based on different viewpoints or perspectives, as well as the accessibility of each display by a given rider. Information presentation can be done asymmetrically on different displays, such as the in-vehicle display screens and the rider's own mobile device(s). For instance, a vehicle-centric perspective may provide information about general operation of the vehicle. This may be done “passively” (from a rider viewpoint), as information about a trip may be presented, e.g., on an in-dash display, without user interaction. In contrast a rider-centric perspective may show the rider information that is of particular importance, that the right time. This may be done “actively” (from the rider's viewpoint), such as by providing a set of virtual vehicle control buttons on a rear in-vehicle display and/or on the rider's mobile device. By way of example, the control buttons may allow the rider to open/close a door or window, turn an interior light on/off, “cast” music or a video from the rider's mobile device to the vehicle's entertainment system, etc. Thus, in one scenario the rider can choose their own user experience, so that they have the controls they need or want, which can be presented on a display at the front or back of the vehicle (or both, such as to accommodate front seat and rear seat riders).

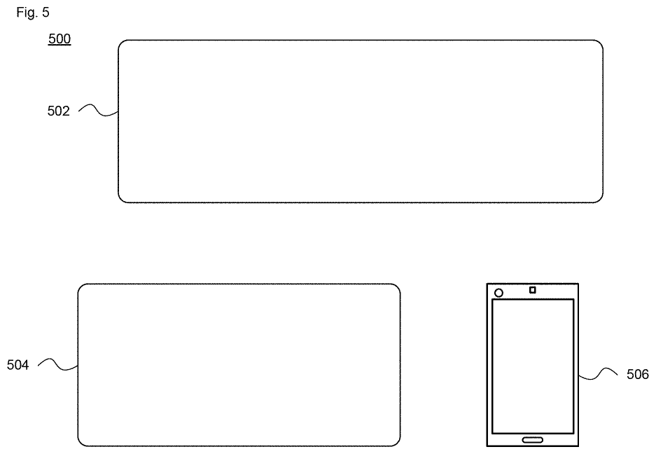

In discussing various scenarios, the general display architecture shown in FIG. 5 will be referenced. As shown in example 500 of FIG. 5, there is a first in-vehicle display 502, a second in-vehicle display 504, and a display of a client device 506. Here, the first display 502 is situated along a front portion of the vehicle cabin, such as display 304 is disposed along the dashboard 302 of FIG. 3A. The first display may be a single display or multiple displays in the front portion of the cabin. The second display 504 is situated along a second portion of the vehicle cabin to the rear of the front portion. This may be, e.g., at a center console (such as 326 of FIG. 3B) or on the back of a seat or headrest (see FIG. 3D). As with display 502, display 504 may be a single display (e.g., 342 of FIG. 3C) or multiple displays (e.g., 362_{L} and 362_{R} of FIG. 3D). The client device 506 may be, e.g., a mobile phone, tablet PC or netbook, wearable device (e.g., glasses or other head-mounted display, smartwatch, etc.). The client device may also provide for multiple displays, such as a dual-screen mobile phone, tablet or laptop.

In a vehicle operating in an autonomous mode that has front seats and one or more rows of rear seats (e.g., a sedan or minivan), there are three general types of rider seating possibilities. First, the rider(s) may be in one of the rear seats with the front seats unoccupied. Second, the rider(s) may be in one of the front seats with the rear seats unoccupied. And third, there may be riders in one or more front seats and one or more rear seats. Each of these types will be considered in turn.

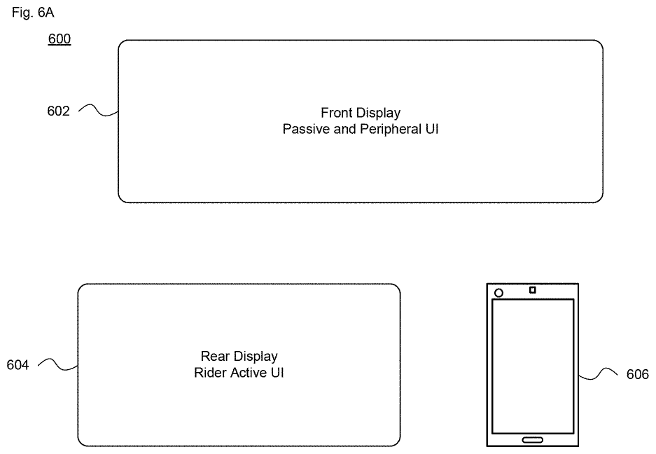

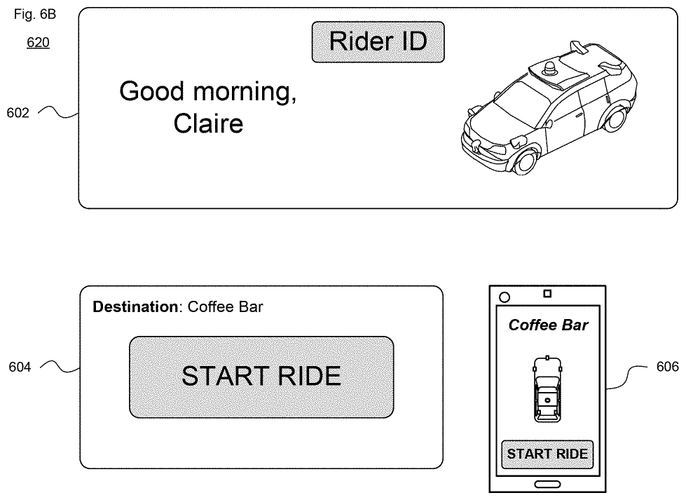

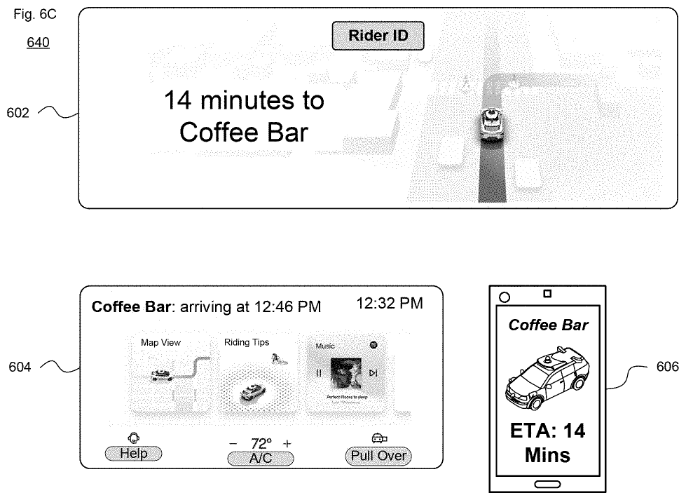

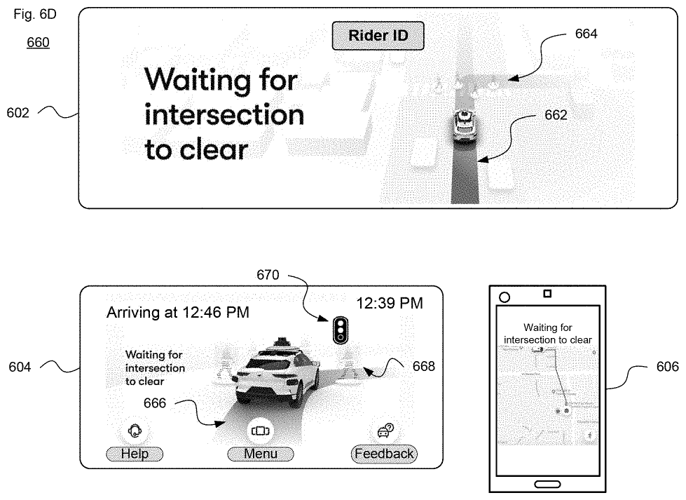

FIG. 6A illustrates a configuration 600 that can be employed in a rear seat rider only configuration. For instance, the vehicle may determine that there is only one passenger seating in a rear seat, such as by detecting that a rear door was opened. This can be confirmed by other sensor information, such as a seatbelt sensor, the press of a “start ride” button adjacent to a rear seat, detection of the rider via a camera of the in-vehicle sensor suite, etc. In this scenario, front screen 602 has a role of a passive and peripheral user interface, while rear screen 604 has a role of a rider active user interface. In this example, client device 606 may provide a set of controls.

FIG. 6B illustrates a view 620 of the different displays prior to starting a trip. As shown, the front screen 602 may greet the rider (“Good morning, Claire”), display rider identification information so the person can confirm they are in the correct vehicle, and show other information such as an image of their vehicle. The rear screen 604 may identify the trip destination (e.g., “Coffee Bar”) and provide a virtual control button to start the ride. The rider's client device 606 may also provide similar information in its UI as shown on the rear screen.

And FIG. 6C illustrates a view 640 of the different displays during the ride. By way of example, content displayed on the front screen 602 may include the vehicle's view of the roadway in front of it and general trip information such as the time to reach the destination. The content may also include one or more monologue messages, in which the vehicle reports its current status to the rider based on the vehicle's knowledge about what is going on in the immediate environment. There are numerous situations where providing the vehicle's monologue to the user can be beneficial. One such situation is the vehicle reporting its current driving status or why it is waiting to take an action. For example, the vehicle may be in a “move along” situation, e.g., where the vehicle needs to drive around the block. Here, the information presented may include a possible drop-off location once the vehicle loops around, a timer indicated an expected arrival time at an updated pullover spot, etc. Other driving-related information in the monologue includes communicating what the vehicle is doing and perceiving, such as yielding to pedestrian, yielding to cyclist, driving slowly through a work zone or school zone, idling at a railroad crossing waiting for a train to pass, yielding for emergency vehicles, etc. The monologue may alternatively or additionally indicate the door lock/unlock status. This information may be presented, for instance, when the vehicle is waiting to depart after picking up a rider.

Information about certain vehicle systems and components may also be presented via the monologue. For instance, this can include informing riders about the window status, such as which windows may be rolled down or which are locked. The system may allow the rider to control operation for opening and closing the windows, such as via virtual control buttons on the client device and/or on the rear display screen.

Similarly, the windshield wiper status or cabin temperature may be presented to or controlled by the rider. Here, while the vehicle may not need to activate the wipers in order to drive autonomously, the rider may want to have a better view of what is happening around the vehicle, and so may turn the wipers on or control the wiper speed. Similarly, the rider may be able to control heating or air conditioning within the cabin, turn the defrosters on or off, etc. In one scenario, information about whether the wipers are on could be an indicator of light rain. In another scenario, precipitation may be detected by one or more of the vehicle sensors. Furthermore, external (ambient) temperature information may also be communicated, for instance to suggest that the rider bundle up before exiting the vehicle.

The monologue may be part of a multi-layer UI stack for different types of notifications. Other notification layers may provide information with various levels of importance/urgency. In one scenario, monologue information may be presented via a single line of text, a bubble or a callout, or other graphics. The information may be displayed (and/or repeated audibly) for as long as the event or condition is true. Thus, the message “Yielding to cyclist” may be displayed along a portion of the UI of the front display 602 until the cyclist has moved away from the vehicle or otherwise clears from the vehicle's planned path. As such, information from the on-board planner and/or perception systems may be continuously evaluated to determine the type of notification to provide and when to stop providing it.

Thus, when the rider is in a rear seat in this scenario, they can easily view the content on the front screen UI when they want to know when they will arrive at their destination or to understand why the vehicle is waiting at an intersection. In contrast, the rear screen 604 provides a rider active UI. This UI may include the same car view as the front screen UI, or a different car view that may be focused on a particular portion of the roadway (e.g., a map-type view of the route over the next 2-3 blocks). The rear screen UI may also include information about in-vehicle entertainment, map information, riding tips, etc. The rear screen UI in this scenario also provides one or more controls (e.g., Help, Pull Over and/or A/C environmental controls) that allow the rider to manage the ride, as well as to request that the vehicle pull over to either add a stop (e.g., the dry cleaners, pharmacy or supermarket) or to end the ride. Here, the rear screen controls may enable the rider to send feedback about the trip or to request assistance from rider support personnel (e.g., via the Help button). As noted above, the control buttons may allow the rider to cast music or a video from the rider's mobile device so that it plays through the vehicle's entertainment system.

As shown in view 660 of FIG. 6D, the front screen UI may provide relevant monologue messages that indicate current vehicle status. Here, for instance, the front screen may explain that the vehicle is “Waiting for intersection to clear”, along with a top perspective map view of the vehicle in relation to the intersection. This may include a highlighted route 662 and icons 664 indicating pedestrians or other road users that are in the intersection. In this example, the rear screen UI may provide a different map view, such as a rear perspective view, along with a truncated route 666, road user icons 668 and other information 670 such as the state of a traffic signal.

Thus, in a rear seat only rider configuration, the front screen UI may be configured to provide monologue information and a vehicle/map view in most situations. Should there be a high-level alert that would interrupt the ride, the monologue messaging may be replaced by a notification about the alert (e.g., “unexpected mechanical issue encountered, rider support is on the way”).

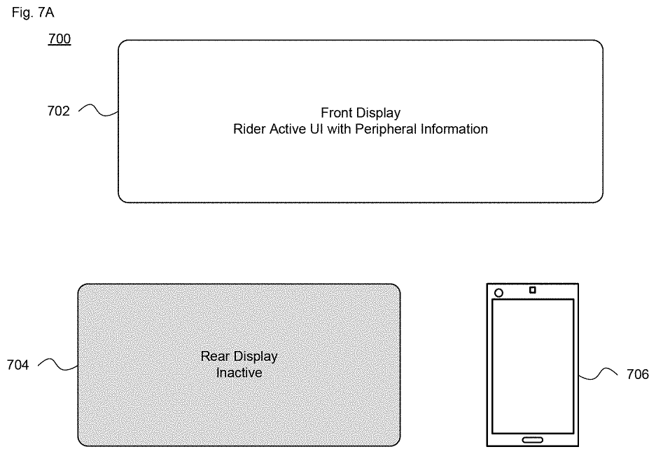

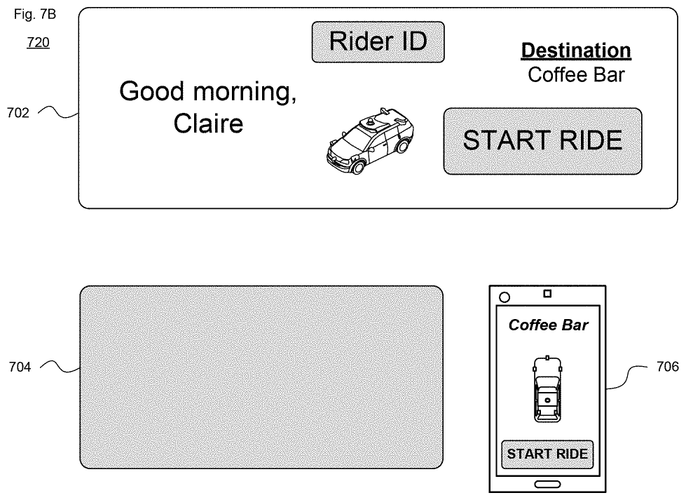

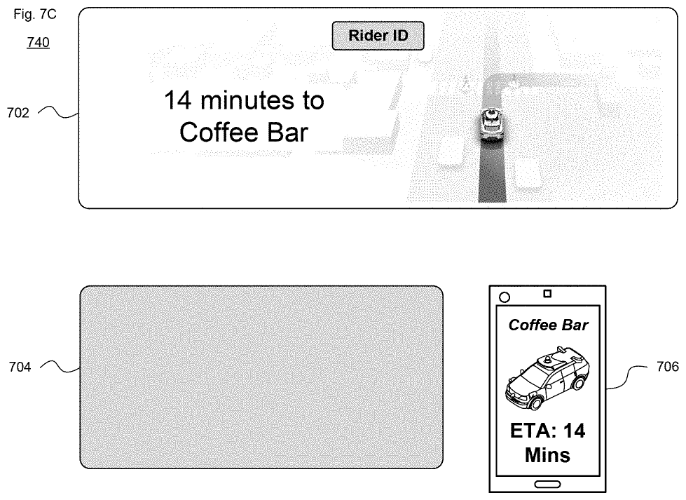

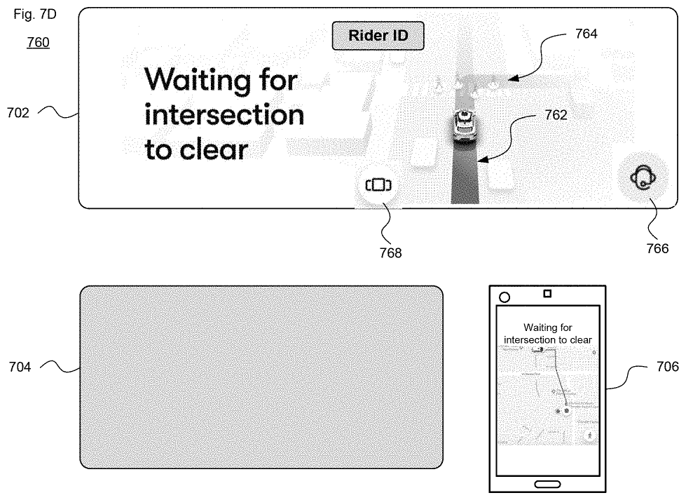

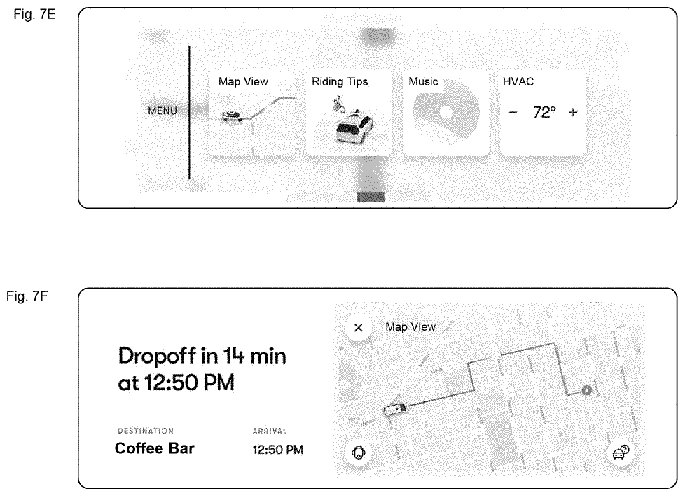

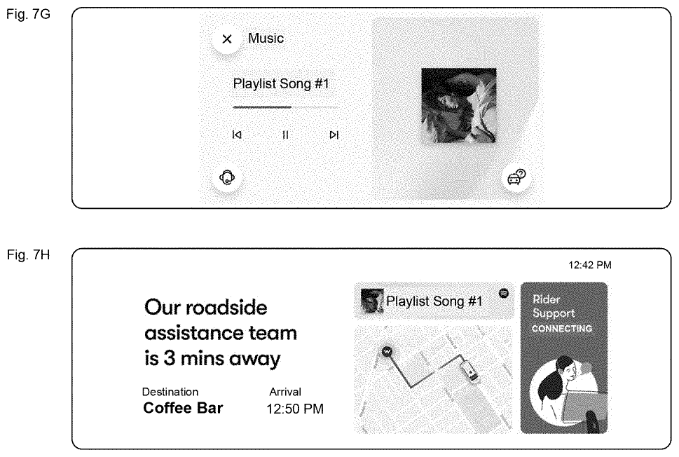

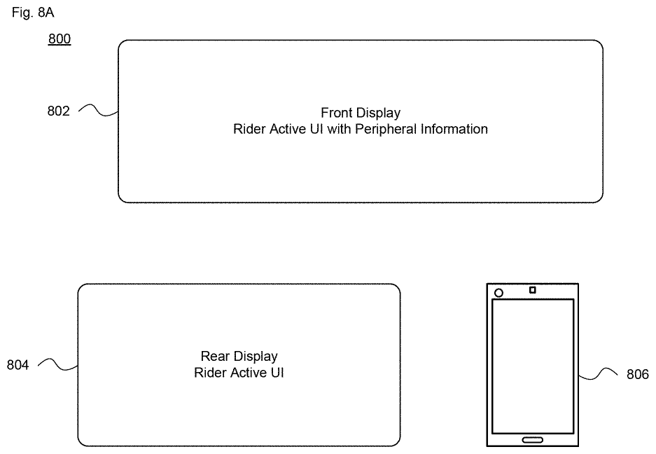

FIG. 7A illustrates a configuration 700 that can be employed in a front seat rider only situation. For instance, the vehicle may determine that there is only one passenger sitting in the front passenger seat, such as by detecting that the front passenger door was opened. This can be confirmed by other sensor information, such as a seatbelt sensor, the press of a “start ride” button adjacent to the dashboard or the rear-view mirror, detection of the rider via a camera of the in-vehicle sensor suite, etc. In this scenario, front screen 702 has a role of an active user interface for the rider, which can be accompanied by peripheral information as needed. Here, rear screen 704 is inactive, which may mean it is turned off or in a standby state (e.g., a dimmed display without displaying ride-related content). In this example, client device 706 may provide a set of controls, such as in the prior scenario of FIGS. 6A-D.

FIG. 7B illustrates a view 720 of the different displays prior to starting a trip. As shown, the front screen 702 may greet the rider (“Good morning, Claire”), display rider identification information so the person can confirm they are in the correct vehicle, and show other information such as an image of their vehicle. Here, because the rider is in a front seat, the front screen 704 may also identify the trip destination (e.g., “Coffee Bar”) and provide a virtual control button to start the ride. The rider's client device 706 may also provide a subset of relevant information in its UI, including the destination, image of the vehicle and/or start ride button.

FIG. 7C illustrates a view 740 of the different displays during the ride. Similar to the scenario of FIG. 6C, content displayed on the front screen 702 may include the vehicle's view of the roadway in front of it and general trip information such as the time to reach the destination, as well as one or more monologue messages in which the vehicle reports its current status to the rider based on the vehicle's knowledge about what is going on in the immediate environment.

As shown in view 760 of FIG. 7D, the front screen UI may provide relevant monologue messages that indicate current vehicle status. Here, for instance, the front screen may explain that the vehicle is “Waiting for intersection to clear”, along with a top perspective map view of the vehicle in relation to the intersection. This may include a highlighted route 762 and icons 764 indicating pedestrians or other road users that are in the intersection. In this example, the front screen UI may provide additional icons for smart buttons, such as a rider support request button 766, as well as a menu button 768 that can be used to access various features and options.

FIGS. 7E-H illustrate examples of other content that may be presented on the front screen during a ride. For instance, the rider pushing menu button 768 would present a menu as shown in FIG. 7E. Here, the menu may include various selections for a map view, riding tips (e.g., information about the autonomous vehicle), music (e.g., to cast music from the rider's device through the vehicle's sound system), and heating/air conditioning controls via an HVAC option. FIG. 7F illustrates an example upon selection of the map view option. Here, the map view may show the current location of the vehicle and the planned route to the destination. This view may also include ride status information, such as the planned drop-off time and destination name. FIG. 7G illustrates an example screen for playing music when the music option is selected. And FIG. 7H illustrates an example where an important notification replaces a monologue message. Here, a roadside assistance notification is presented to the rider. Other information, such as details about rider support, any playing music and/or a zoomed-in map, may also be presented on the front screen UI. In this scenario, some or all of the information presented on the front screen may be presented, in whole or in part (e.g., scaled down) on the client device display(s).

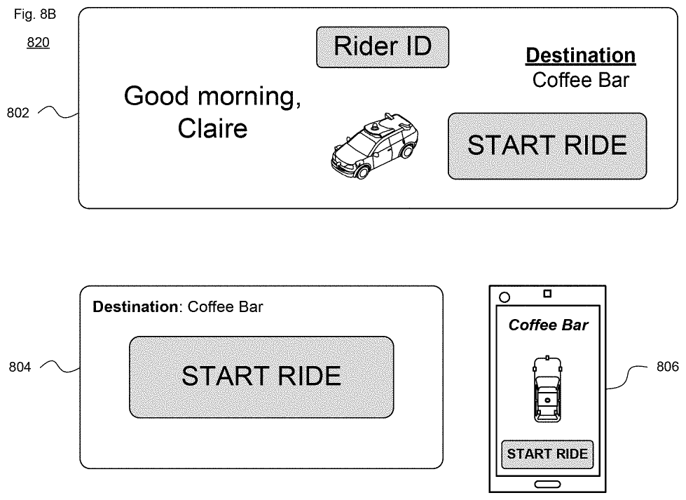

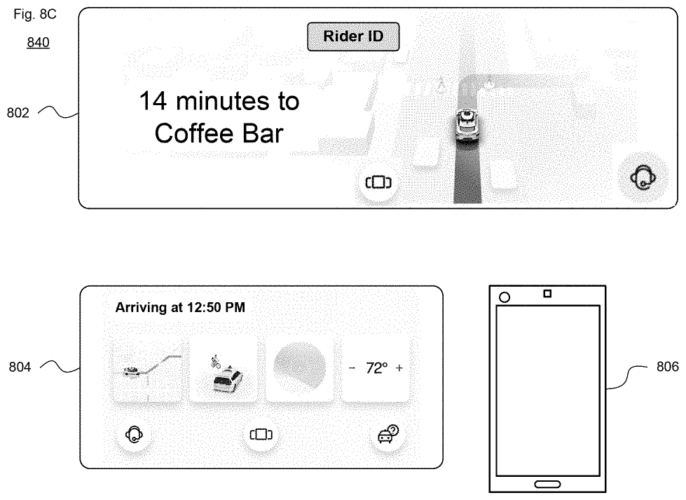

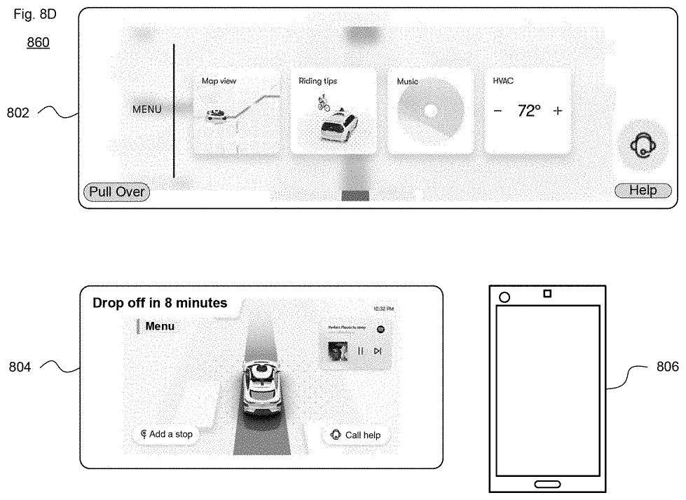

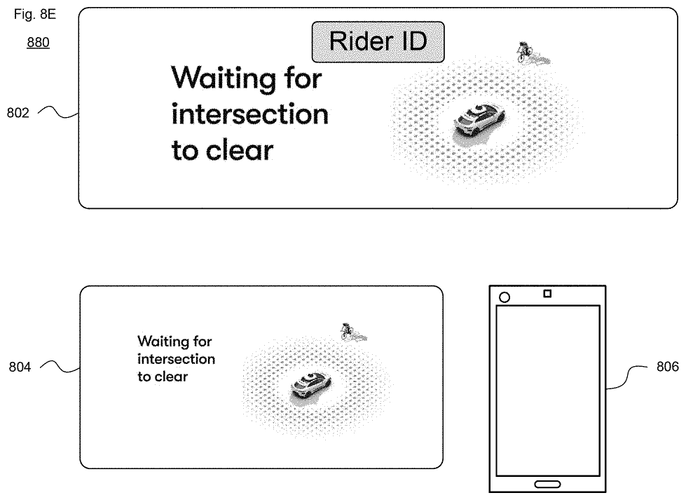

FIG. 8A illustrates a different configuration 700 that can be employed when there are riders in both the front and rear seats. For instance, the vehicle may determine that there are multiple passengers, e.g., sitting in the front passenger seat and one or more rear seats, such as by detecting that the front passenger door and one of the rear doors were opened. This can be confirmed by other sensor information, such as a seatbelt sensor, the press of a “start ride” button adjacent to the dashboard or the rear view mirror, detection of the rider via a camera of the in-vehicle sensor suite, etc. In this scenario, similar to the one of FIGS. 7A-7H, front screen 802 has a role of an active user interface which is beneficial for the front seat rider, which can be accompanied by peripheral information as needed. Here, rear screen 804 also provides an active rider UI, with information and controls similar to those described above in FIGS. 6A-D. In this example, client device 806 may provide a set of controls, such as in the prior scenario of FIGS. 6A-D or FIGS. 7A-H.

As shown in view 820 of FIG. 8B, because both the front and rear screen UIs are rider active, a rider in either the front seat or rear seat may be able to start the ride by pressing the Start Ride button on their respective in-vehicle display. Alternatively, the ride may be initiated via a Start Ride button on the client device of any of the riders. Once the ride commences, the same or different information may be presented on the front and rear screen UIs. For instance, as shown in view 840 of FIG. 8C, general trip information (e.g., a map with current route) and a monologue message may be presented in the front screen UI. In this example, the menu of options may be presented in the rear screen UI. Similar to FIGS. 7F-H, the rear seat rider may access any of the menu options as desired. In contrast, as shown in view 860 of FIG. 8D, the menu may be presented on the front screen UI while the rear screen UI shows a close-up map with current route, including options to add a stop, call for assistance and/or to cast music or other content from a rider's client device through the vehicle's entertainment system.

In fact, any of the content presented on the front screen UI (or rear screen UI) may also be presented on the rear screen UI (or front screen UI). This may be done in a mirroring scenario, where both front and rear screen UIs present the same types of information (e.g., monologue messages and/or current route) at the same time. Mirroring may be particularly useful for certain information, such as important status messages (e.g., traffic has added 10 minutes to the trip) or there is an urgent notification for the riders. View 880 of FIG. 8E shows an example of content mirroring between the front and rear displays UIs. Mirroring may include presenting identical information that may or may not be scaled for the screen size of each display. Mirroring may also include presenting equivalent information on the different screens, with other information overlayed on one screen but not the other. For instance, since the front screen display may be larger, the “Waiting for intersection to clear” message in front screen 802 may also include a map to show nearby points of interest and/or the planned route over the next few blocks.

Content may also be alternated or otherwise switched between the different screen UIs. In other situations, because all riders may be able to see the front screen UI while only the rear seat riders can see the rear screen UI, more general or background information (e.g., overall route and/or monologue messages) may be displayed on the front screen and not the rear screen. Here, any rider would be able to look at the front screen for that type of information if desired. This can help to eliminate information overload on any given display, or across all displays.

Information presented on the in-vehicle displays may also be mirrored or otherwise presented on the rider(s) client device(s). Since the display size may be a factor, information may be scaled or reorganized for ease of viewing or use of relevant control buttons. The information may be transmitted to the rider(s) client device(s), such as a mobile phone, smart watch, tablet PC, etc. The transmission may be done indirectly, from the vehicle to a back-end system and then to the client device(s) (e.g., via a cellular or other wireless communication link), or directly from the vehicle to the client device(s) (e.g., using a Bluetooth™, NFC or other ad hoc wireless communication link).

For instance, in one implementation the information transmitted to the rider's client device originates from the vehicle. This information may be routed through a remote server, for instance as part of a fleet management system. In one scenario, the server would decide whether to message the user and how to message the user. In another scenario, the vehicle and the server both transmit status information to the user's device. This may be done in collaboration between the vehicle and the server, or independently. For instance, the vehicle may provide one set of information regarding what the vehicle sees in its environment and how it is responding to what it sees, while the server may provide another set of information, such as traffic status farther along the route or other contextual data. In these scenarios, the software (e.g., app) running on the rider's device may be configured to select what information to show, and when to show it, based on the received data. One or both of the vehicle or the server may select different communication strategies based on the pickup status of the user (i.e., awaiting pickup or picked up and in the vehicle). Alternatively or additionally, or the app or other program on the rider's device may select different communication strategies. This may be based on the ride status, the type(s) of information received, available communication link(s), etc.

### Display Flexibility and Content Switching

As noted above, depending on where riders sit and/or what they are looking at, the system could change the focal point(s) for information display. For instance, if each rider has a line-of-sight view of the front display, then general information about ride status may be presented on the front display's UI. However, a smaller rider in a rear seat (e.g., rider 4022 of FIG. 4A) may have difficulty seeing a front display disposed along the dashboard. In this case, the system may present the general information in a mirrored manner on both the front display and a rear display (e.g., in a center console or display positioned on a seat back in front of that rider.

In one scenario, each time a new rider enters the vehicle and is seated, the system may determine which in-vehicle displays are viewable by that rider and select how to present content to that rider accordingly. And if fewer than all riders depart the vehicle, the system may evaluate whether any remaining riders have changed seating positions and select how to present content to those riders. In addition, regardless of a rider's seated position, if the pose of a rider changes (e.g., position in the seat and orientation relative to a nominal feature of the vehicle, such as their placement relative to the front display screen or center console) and/or the gaze direction of the rider changes, the system may change which information is presented on any given display. Furthermore, information may be presented to the rider(s) differently depending on whether they are viewing information on their device's app or via one or more of the in-vehicle displays.

While different displays may be viewable to a given rider, the distance from the rider to each screen may also affect what or how information is presented. Thus, in a rear seat only situation, while the rider may have an unobstructed view of both a center console display and a dashboard-based front display, the system may change the font size to make text more readable on the front display.

In another scenario, the social aspect of the ride may be taken into account when selecting which screens to present information on. Here, by way of example, the system may choose to present certain notifications on one display that is viewable by all riders, either because the notifications are important (e.g., ride support requested) or there is a shared experience (e.g., a music playlist that the riders may all choose from).

In still another scenario, there may be shared controls and dedicated controls that can be presented to some or all of the riders. For instance, a music selection control may be available on front and rear displays, in addition to each rider's device. Here, each rider could select songs to play. Climate controls may be presented on different displays, but may be associated with a respective zone of the vehicle (e.g., separate climate controls for each rider's location).

The controls may also be asymmetrical, for instance where a given control is oriented to a primary rider (e.g., the rider in the front seat) but accessible to the other riders as well. Here, input from the primary rider may take precedence over selections from other riders. So while a rider in a rear seat may request a stop before the final destination (e.g., for the dry cleaner), the rider in the front seat may override that request. Or, alternatively, the rider who requested the trip may be provided with controls on the app at their client device that are not provided to other riders in the party.

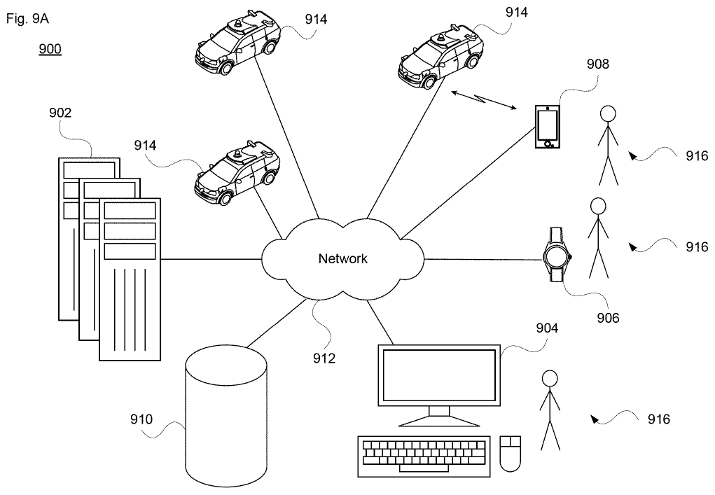

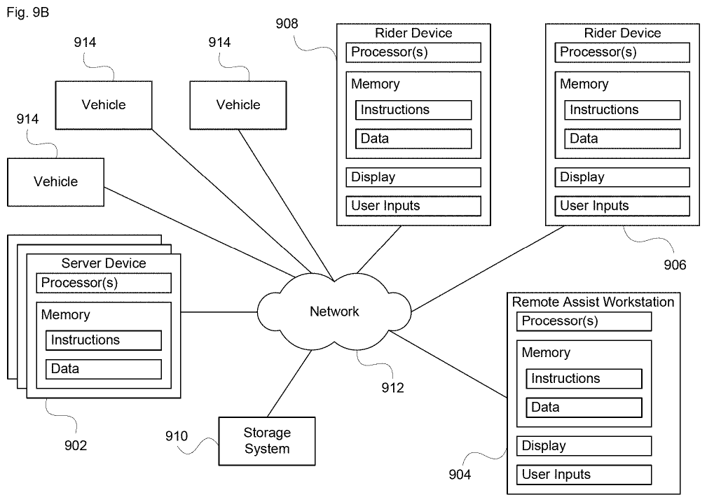

FIGS. 9A-B illustrate general examples of how information may be communicated between the vehicle and the rider(s).

In particular, FIGS. 9A and 9B are pictorial and functional diagrams, respectively, of an example system 900 that includes a plurality of computing devices 902, 904, 906, 908 and a storage system 910 connected via a network 912. System 900 also includes vehicles 914, which may be configured the same as or similarly to vehicles 100 and 120 of FIGS. 1A-B and 1C-D, respectively. Vehicles 914 may be part of a fleet of vehicles. Although only a few vehicles and computing devices are depicted for simplicity, a typical system may include significantly more.

As shown in FIG. 9B, each of computing devices 902, 904, 906 and 908 may include one or more processors, memory, data and instructions. Such processors, memories, data and instructions may be configured similarly to the ones described above with regard to FIG. 2. The various computing devices and vehicles may communication via one or more networks, such as network 912. The network 912, and intervening nodes, may include various configurations that support short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 902 may include one or more server computing devices having a plurality of computing devices, e.g., a load balanced server farm, that exchange information with different nodes of a network for the purpose of receiving, processing and transmitting the data to and from other computing devices. For instance, computing device 902 may include one or more server computing devices that are capable of communicating with the computing devices of vehicles 914, as well as computing devices 904, 906 and 908 via the network 912. For example, vehicles 914 may be a part of a fleet of vehicles that can be dispatched by a server computing device to various locations. In this regard, the computing device 902 may function as a dispatching server computing system which can be used to dispatch vehicles to different locations in order to pick up and drop off riders or to pick up and deliver food, dry cleaning, packages or cargo. In addition, server computing device 902 may use network 912 to transmit and present information to a user of one of the other computing devices or a rider of a vehicle. In this regard, computing devices 904, 906 and 908 may be considered client computing devices.

As shown in FIG. 9A each client computing device 904, 906 and 908 may be a personal computing device intended for use by a respective user 716, and have all of the components normally used in connection with a personal computing device including a one or more processors (e.g., a central processing unit (CPU)), memory (e.g., RAM and internal hard drives) storing data and instructions, a display (e.g., a monitor having a screen, a touch-screen, a projector, a television, or other device such as a smart watch display that is operable to display information), and user input devices (e.g., a mouse, keyboard, touchscreen or microphone). The client computing devices may also include a camera for recording video streams, speakers, a network interface device, and all of the components used for connecting these elements to one another. As indicated in FIG. 9B, device 906 or 908 may be the device of a rider who is currently in the vehicle.

By way of example only, client computing devices 906 and 908 may be mobile phones or devices such as a wireless-enabled PDA, a tablet PC, a wearable computing device (e.g., a smartwatch), or a netbook that is capable of obtaining information via the Internet or other networks.

In some examples, client computing device 904 may be a remote assistance workstation used by an administrator, operator or rider support agent to communicate with riders of dispatched vehicles, or users awaiting pickup. Although only a single remote assistance workstation 904 is shown in FIGS. 9A-B, any number of such workstations may be included in a given system. Moreover, although workstation 904 is depicted as a desktop-type computer, the workstation 904 may include various types of personal computing devices such as laptops, netbooks, tablet computers, etc.

Storage system 910 can be of any type of computerized storage capable of storing information accessible by the server computing devices 902, such as a hard-drive, memory card, ROM, RAM, DVD, CD-ROM, flash drive and/or tape drive. In addition, storage system 910 may include a distributed storage system where data is stored on a plurality of different storage devices which may be physically located at the same or different geographic locations. Storage system 910 may be connected to the computing devices via the network 912 as shown in FIGS. 7A-B, and/or may be directly connected to or incorporated into any of the computing devices.

In a situation where there are riders, the vehicle or remote assistance personnel may communicate directly or indirectly with the riders' client computing device. Here, for example, information may be provided to the passengers regarding current driving operations, changes to the route in response to the situation, etc. As explained above, information may be passed from the vehicle to the riders via the vehicle's monologue and general display UI configuration. For instance, when the vehicle arrives at the pickup location or the rider enters the vehicle, the vehicle may communicate directly with the user's device, e.g., via a Bluetooth™ or NFC communication link. Communication delays (e.g., due to network congestion, bandwidth limitations, coverage dead zones, etc.) may be factored in by the vehicle when deciding what specific information is provided by the monologue.

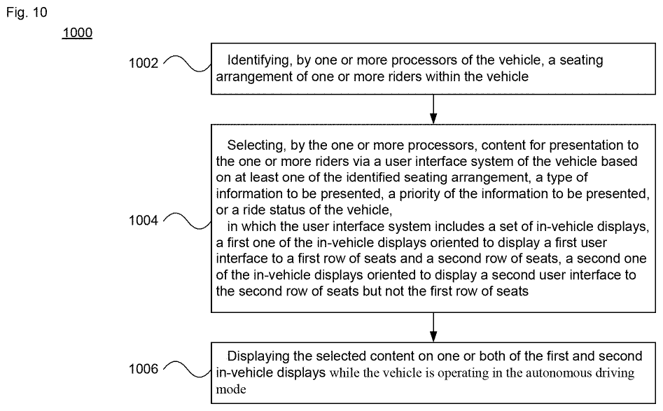

FIG. 10 illustrates a method of operation in accordance with the foregoing. In particular, this figure illustrates a computer-implemented method 1000 for a vehicle configured to operate in an autonomous driving mode. At block 1002 the method includes identifying, by one or more processors of the vehicle, a seating arrangement of one or more riders within the vehicle. At block 1004 the method includes selecting, by the one or more processors, content for presentation to the one or more riders via a user interface system of the vehicle based on at least one of the identified seating arrangement, a type of information to be presented, a priority of the information to be presented, or a ride status of the vehicle. The user interface system includes a set of in-vehicle displays, a first one of the in-vehicle displays oriented to display a first user interface to a first row of seats and a second row of seats, a second one of the in-vehicle displays oriented to display a second user interface to the second row of seats but not the first row of seats. And at block 1006, the method includes displaying the selected content on one or both of the first and second in-vehicle displays while the vehicle is operating in the autonomous driving mode.

Finally, as noted above, the technology is applicable for various types of vehicles, including passenger cars, buses, RVs and trucks or other cargo carrying vehicles.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements. The processes or other operations may be performed in a different order or simultaneously, unless expressly indicated otherwise herein.

1. A vehicle configured to operate in an autonomous driving mode, the vehicle comprising:
a perception system including one or more sensors, the one or more sensors being configured to receive sensor data associated with objects in an external environment of the vehicle;
a driving system including a steering subsystem, an acceleration subsystem and a deceleration subsystem to control driving of the vehicle;
a positioning system configured to determine a current position of the vehicle;
a user interface system including a set of in-vehicle displays, a first one of the in-vehicle displays oriented to display a first user interface to a first row of seats and a second row of seats, a second one of the in-vehicle displays oriented to display a second user interface to the second row of seats but not the first row of seats; and
a control system including one or more processors, the control system operatively coupled to the driving system, the perception system, the positioning system and the user interface system, the control system being configured to:
identify a seating arrangement of one or more riders within the vehicle;
select content for presentation to the one or more riders via the user interface system, based on at least one of the identified seating arrangement, a type of information to be presented, a priority of the information to be presented, or a ride status of the vehicle; and
display the selected content on one or both of the first and second in-vehicle displays.

2. The vehicle of claim 1, wherein identification of the seating arrangement includes identifying which seat each of the one or more riders is seated in.

3. The vehicle of claim 1, wherein display of the selected content on one or both of the first and second in-vehicle displays is further based on at least one of a gaze direction of a given one of the one or more riders, the given rider's seated pose, or a line-of-sight visibility between the given rider and each of the set of in-vehicle displays.

4. The vehicle of claim 1, wherein the first in-vehicle display is disposed on or adjacent to a dashboard of the vehicle.

5. The vehicle of claim 4, wherein the second in-vehicle display is in a console disposed between either the first row of seats or the second row of seats.

6. The vehicle of claim 4, wherein the second in-vehicle display is disposed along a seat back or a headrest of one of the first row of seats.

7. The vehicle of claim 1, wherein identification of the seating arrangement is based on information from one or more interior sensors of the vehicle.

8. The vehicle of claim 1, wherein the control system is further configured to transmit a portion of the content to a client device of a given one of the one or more riders for presentation to the given rider.

9. The vehicle of claim 8, wherein the portion of the content is a subset of the content selected for display on one or both of the first and second in-vehicle displays.

10. The vehicle of claim 1, wherein the first user interface is a peripheral user interface and the second user interface is a rider active user interface.

11. A computer-implemented method for a vehicle configured to operate in an autonomous driving mode, the method comprising:
identifying, by one or more processors of the vehicle, a seating arrangement of one or more riders within the vehicle;
selecting, by the one or more processors, content for presentation to the one or more riders via a user interface system of the vehicle based on at least one of the identified seating arrangement, a type of information to be presented, a priority of the information to be presented, or a ride status of the vehicle, in which the user interface system includes a set of in-vehicle displays, a first one of the in-vehicle displays oriented to display a first user interface to a first row of seats and a second row of seats, a second one of the in-vehicle displays oriented to display a second user interface to the second row of seats but not the first row of seats; and
displaying the selected content on one or both of the first and second in-vehicle displays while the vehicle is operating in the autonomous driving mode.

12. The computer-implemented method of claim 11, wherein identifying the seating arrangement includes identifying which seat each of the one or more riders is seated in.

13. The computer-implemented method of claim 11, wherein displaying the selected content on one or both of the first and second in-vehicle displays is further based on at least one of a gaze direction of a given one of the one or more riders, the given rider's seated pose, or a line-of-sight visibility between the given rider and each of the set of in-vehicle displays.

14. The computer-implemented method of claim 11, wherein identifying the seating arrangement is based on information obtained from one or more interior sensors of the vehicle.

15. The computer-implemented method of claim 11, further comprising transmitting a portion of the content to a client device of a given one of the one or more riders for presentation to the given rider.

16. The computer-implemented method of claim 15, wherein the portion of the content is a subset of the content selected for display on one or both of the first and second in-vehicle displays.

17. The computer-implemented method of claim 11, wherein the first user interface is a peripheral user interface and the second user interface is a rider active user interface.

18. The computer-implemented method of claim 17, wherein the rider active user interface includes a set of virtual vehicle control buttons that enable a given rider to control one or more features of the vehicle.

19. The computer-implemented method of claim 18, wherein the one or more features of the vehicle include at least one starting a ride, adding a stop to the ride, or requesting remote assistance.

20. The computer-implemented method of claim 18, wherein the one or more features of the vehicle include an option to cast content from a client device of a given one of the one or more riders through an entertainment system of the vehicle.
